(19) United States
(12) Patent Application Publication
(10) Pub. No.: US 2012/0084205 A1
(43) Pub. Date: Apr. 5, 2012

(54) DISCONNECTED PERSON-TO-PERSON PAYMENT SYSTEM AND METHOD INCLUDING INDEPENDENT PAYOR AND PAYEE DIRECTION FOR VALUE SOURCE AND DESTINATION

(76) Inventors: Sanjeev Dheer, New York, NY (US); David Cooper, Los Gatos, CA (US)

(21) Appl. No.: 13/251,947

(22) Filed: Oct. 3, 2011

Related U.S. Application Data
(60) Provisional application No. 61/389,072, filed on Oct. 1, 2010.

(51) Int. Cl. G06Q 40/02

(52) U.S. Cl. 705/42

(57) ABSTRACT

Embodiments of the person-to-person (P2P) payment system and method described herein include a payor (“sender”) who is a member of a P2P payment network initiating a payment transaction by specifying an identity of a payee (“receiver”) to receive funds and a source value form. The identity of the receiver comprises an email address or a telephone number, to name two examples. The receiver may or may not be in the P2P payment network. The receiver may choose a destination account and destination value form for the funds. The destination account need not be in the P2P network. The destination value form need not be the same as the source value form.

### RELATED APPLICATIONS

This application claims the benefit of U.S. Provisional Patent Application No. 61/389,072, filed Oct. 1, 2010. This application is also related to the following U.S. patent applications Ser. Nos. 11/348,535, filed Feb. 6, 2006; 11/879,818, filed Jul. 19, 2007; 12/109,309, filed Apr. 24, 2008; 12/109,318, filed Apr. 24, 2008; 12/543,497, filed Aug. 18, 2009; 12/543,501, filed Aug. 18, 2009; 12/968,189, filed on Dec. 14, 2010; and 13/092,908, filed Apr. 22, 2011. All of the foregoing applications are incorporated in their entirety herein by reference.

### BACKGROUND

Presently, there are various facilities available for making payments from one person or entity to another person or entity online using the Internet. The assignee of the current application has filed multiple patent applications related to this capability. For example, the current assignee has disclosed capabilities including online invoicing and inter-bank person-to-person (P2P) payment networks. These disclosures include online invoicing, inter-bank email, and mobile P2P payments networks. In addition, the foregoing has been extended to include inter-bank invoicing and internetworking among and between various P2P networks.

Currently, users of these P2P networks who wish to send funds to another person (these users are also referred to as senders or payors) choose a source of funds and also a “value form”, or “form of value”. Value forms include, but are not limited to: automated clearing house (ACH) funds (typically funds from a user account in a bank or other financial institution (FI)); credit card funds; and pre-paid card funds. The person designated by the sender to receive funds (also referred to as the recipient or payee) traditionally received the funds as the same value form sent. The recipient could not choose a different value form than the sender.

### BRIEF DESCRIPTION OF THE DRAWINGS

FIG. 1 is a block diagram of a payment system according to an embodiment.

FIG. 2 is a diagram of a various components of a subsystem illustrating an embodiment of communication paths for the disconnected peer-to-peer payment system and method.

FIG. 3 is a diagram showing the disassociation of sender (source) value form and recipient (destination) value form.

FIG. 4 is a diagram of various value transfer and possible transformation scenarios as carried out at the initiation of the sender.

FIG. 5 is a diagram further illustrating sender options for accessing the POPMoney P2P network.

FIG. 6 is a flow chart of a sender-side process of transferring value according to an embodiment.

FIG. 7 is a flow chart of a recipient-side process of transferring value according to an embodiment.

### DETAILED DESCRIPTION

Embodiments described extend P2P email/mobile money transfer systems to enable the transfer of value between a sender and recipient such that the source and type of value is disconnected from the form of value or type of account into which a recipient receives the funds.

A separation may be effected between the way a sender (or payor) chooses to send value and the way in which a recipient (or payee) chooses to receive it. The sender's choice of payment may be separated from the recipient's mode or form of acceptance of it. For example, the sender may pay the recipient by credit or debit card, but the recipient may choose to load the money on a pre-paid card. As another example, the sender may send cash and the recipient may choose to receive it on a credit or debit card.

In an embodiment, the payment system may be thought of as three discrete but linked concepts. The first may be the source of value that the sender chooses to send from (or in some cases the form of value, also, such as gift card instead of cash). The sender may choose to send value as cash from a bank account, charge the transaction to his credit or debit card or draw funds from his pre-paid card. The second concept is the way in which the sender communicates with the recipient or how he identifies the recipient. In an embodiment, the sender may send the payment in one of three ways: recipient's email address, recipient's mobile phone number; or recipient's account number (which could be the number of a bank account; credit, debit, or pre-paid card; or any other type of destination account). The third concept is the form in which the recipient receives the value.

The system and method as described herein with these inter-linking concepts enables a complete disassociation between the form in which a sender sends value and the manner in which a recipient receives value. The recipient may choose to receive the value in exactly the same form in which the sender sent it, or in a different form. The recipient may choose to direct the funds to his bank or card account, pick up cash at an agent location, or load up a pre-paid card. There are other variations of this disassociation. For example, with a form of value such as a gift card or pre-paid card, the sender may send the recipient a pre-paid card on the recipient's email address or mobile phone number. The recipient may choose to receive the value at a physical address or to receive and use it as an ecard or virtual card. These examples are only meant to be illustrations and are not exhaustive.

The system is further described below within the context of a bank-centric P2P model. Examples of such bank-centric P2P models are those described and claimed in the patent applications incorporated by reference herein. In such a bank-centric model, users may initiate payments from within their bank's online banking or mobile banking portal, and direct the payment to the email address or mobile phone number of the recipient. The recipient may receive the funds within the online or mobile banking portal of their bank if their bank belongs to the P2P payment network. If the recipient's bank does not, then the funds may be received at a bank of the recipient's choosing by accessing a common site by providing the information pertaining to the destination account of the recipient's choice.

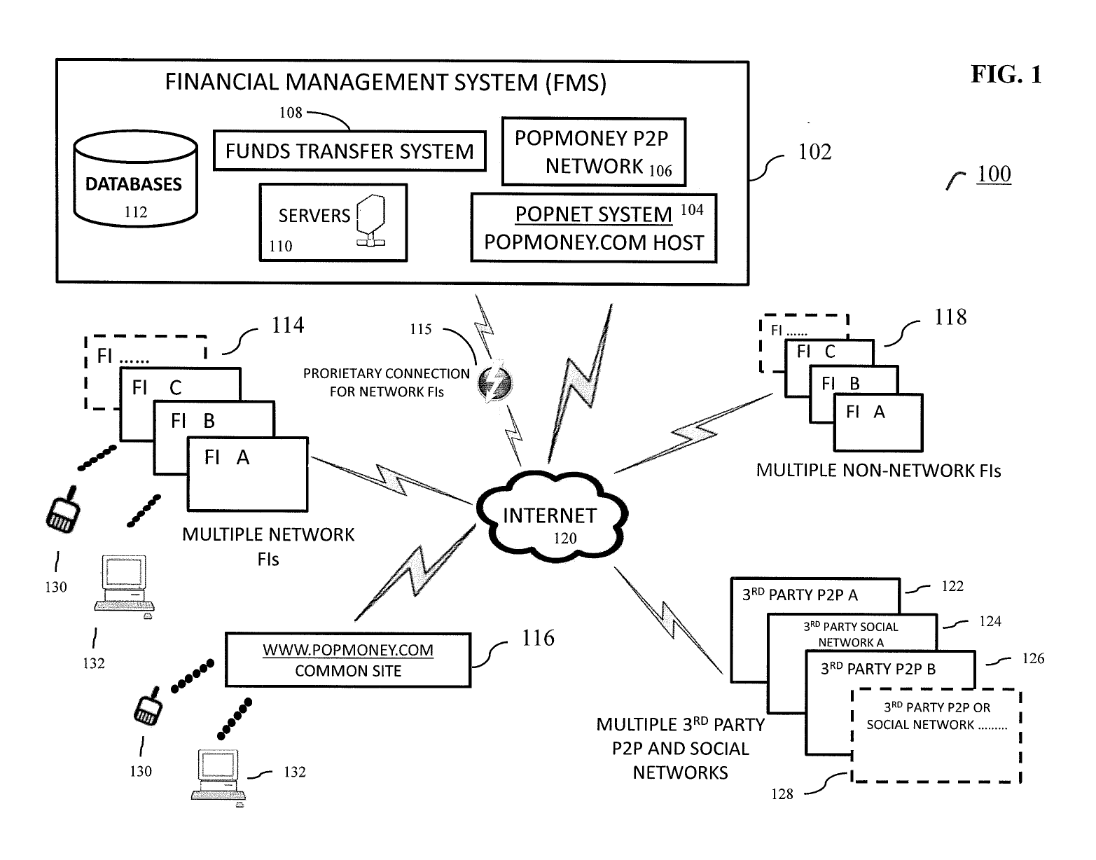

FIG. 1 is a block diagram of a payment system according to an embodiment. System 100 includes a financial management system (FMS) 102 coupled to the Internet 120, and therefore coupled to any devices or networks coupled to the interne 120. FMS 102 includes a funds transfer system 108, databases 112, and servers 110. Databases 112 store a variety of data regarding financial institutions (FIs), and a variety of data regarding users, such as user identification (ID) tokens or data. FMS 102 further includes a P2P network 106. The POPmoney® network as provided by Cashedge, Inc. will be used as an example of a proprietary P2P network 106 herein. POPmoney® P2P network 106 is related to POPNet® system 104. POPNet® system 104 includes internetworking protocols and system components that facilitate the communication of network 106 with other, similar networks. In various embodiments, the P2P network 106 may be understood not as a network in the physical sense, but as a set of net includes POPmoney network interface components in the strict sense, but may rather include POPMoney network interface components. An example of an architecture is given in FIG. 1. For example, the FMS 102 is shown as residing in a location. However, the elements identified and described could reside anywhere in a distributed fashion, or in the “cloud”.

POPNet® system 104, in an embodiment, hosts a proprietary, common web site for accessing network 106. This web site will be referred to here as www.POPMoney.com 116, a web site provided by Cashedge, Inc. However, www.POPMoney.com is used for purpose of illustration. The claimed invention is not limited to a particular common web site as described herein.

System 100 also includes multiple network FIs 114. A network FI is a member of the POPmoney® P2P network 106. Network FIs 114 further include entities that are not traditionally thought of as financial institution, such as pre-paid cards, for example. FIs 114 may include any type of entity that can store, receive, and disburse funds for a customer.

As a member of network 106, as further explained below, customers of the network FI 114 may access the POPmoney® P2P network 106 through a web site of the network FI 114. In an embodiment, the network FI 114 uses a software widget provided by POPmoney® P2P network 106 on its relevant systems so that its customers may navigate directly from the web site of the network FI to the POPmoney® P2P network 106 and use any of the services the network FI has chosen to make available to its customers.

Customers of network FIs 114 may access FI 114 web sites using any well-known communication device, such as a personal computer 132, or a personal digital assistant (PDA) 130. PDAs 130 include mobile phones, tablet computers, and any other available handheld device with the capability of accessing the internet.

In an embodiment, network FIs 114 are coupled to FMS 102 using a proprietary network connection 115, but that is not a requirement.

As further described below, users of the POPmoney® P2P network 106 may access the network 106 using a proprietary web site www.POPMoney.com 116. Users may access web site 116 using any PDA 130 or PC 132.

It may also be possible for users of POPmoney® P2P network 106 to access the network 106 and its services through any one of multiple third-party P2P networks and social networks, such as networks 122, 124, 126, and 128. Examples of third-party P2P networks are Obopay™ or MasterCard's Moneysend™. Examples of social networks are Facebook™ and Myspace™. As with network FIs 114, in order for a user to access the POPmoney® P2P network 106 through a third-party P2P network or social network, the third-party P2P network or social network, in an embodiment, includes a software widget provided by the POPmoney® P2P network 106.

System 100 further includes multiple non-network FIs 118. As described in related application previously cited and incorporated herein by reference, the FMS 102 may access user accounts at FIs 118 using account holder credentials and account information provided in the course of a transaction, such as the transactions to be described below.

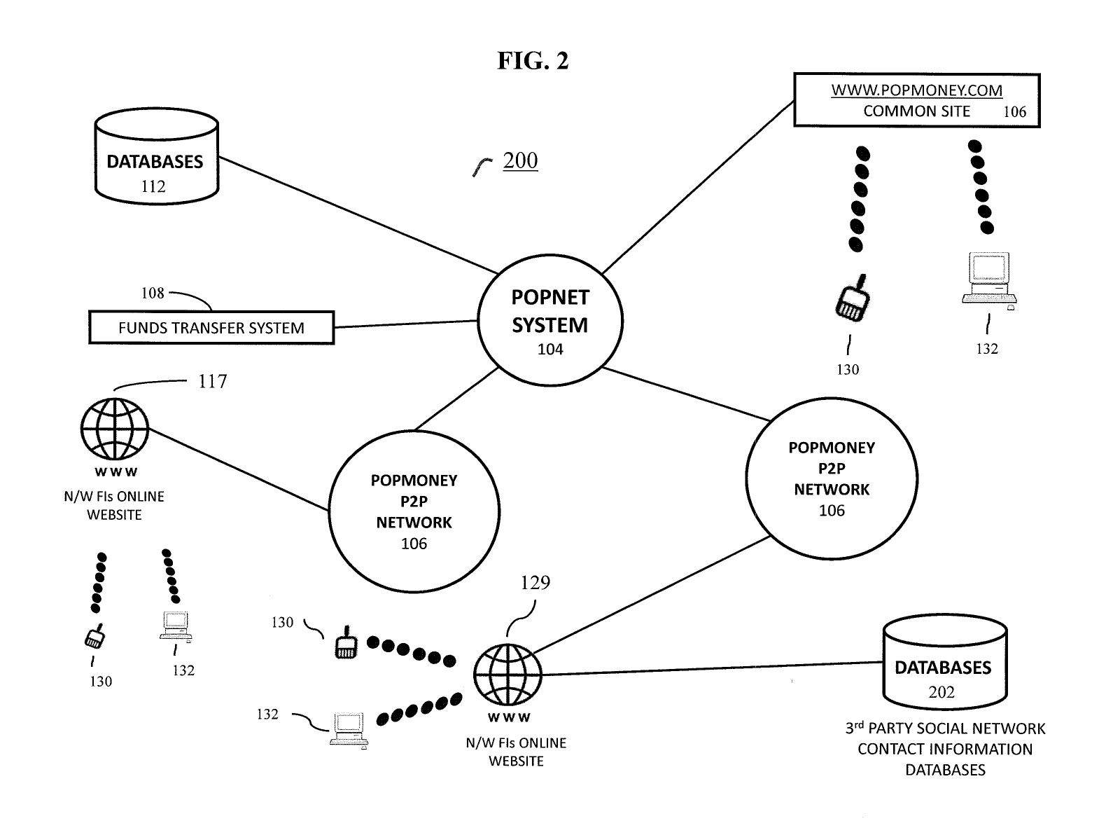

FIG. 2 is a diagram of a various components of a subsystem 200 illustrating an embodiment of communication paths for the disconnected peer-to-peer payment system and method. POPNet system 104 communicates with databases 112 and with fund transfer system 108 in order to execute a payment instruction directed by a sender as further described below. www.POPMoney.com 116, as mentioned previously may be hosted by POPNet system 104, including the user interface for www.POPMoney.com 116. POPNet system 104 communicates with network FIs 114 through their respective web sites 117 via POPMoney network 106. POPNet system 104 includes internetworking protocols, various logic, and rules used by via POPMoney network 106. Users access web sites 117 using any PC 132 or PDA 130.

POPNet system 104 communicates with web sites 129 of third-party P2P networks and social networks (such as 122, 124, 126, and 128) via POPMoney network 106. Third-party P2P networks and social networks also access their respective user contact information databases 302 in the course of completing transactions in POPMoney network 106.

Users may access web sites 129, and www.POPMoney.com 116 using any PDA 130 or PC 132.

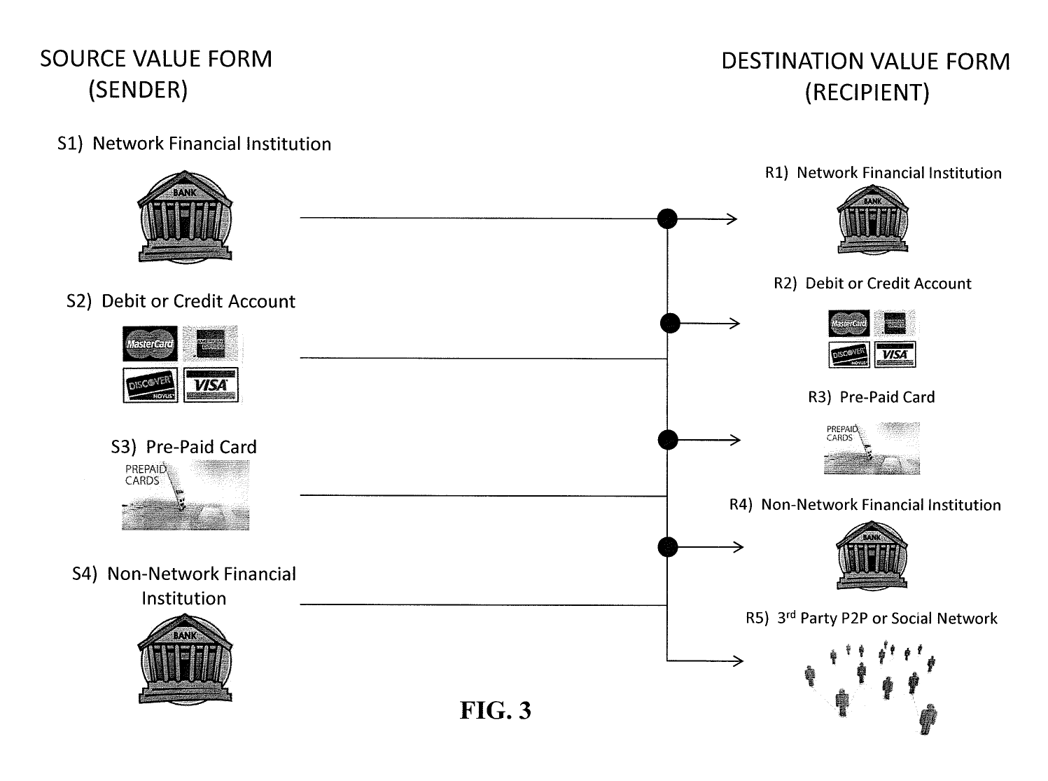

FIG. 3 is a diagram showing the disassociation of sender (source) value form and recipient (destination) value form. The sender may request that value be sourced as funds from a network financial institution, as shown at S1. These funds are typically transferred in ACH transaction, and may be referred to as ACH funds. According to the choice of the receiver, the ACH funds sourced at S1 may be received as any of the value types shown on the right of the diagram. R1 represents receipt of the funds from S1 in the same form of value as that sent, or ACH funds into a network FI. R2 represents the ACH funds from S1 being received as a different form of value, that is, funds placed on a credit card. R3 represents the ACH funds from S1 being received as a different form of value, that is, funds placed on a pre-paid card. R4 represent the ACH funds from S1 being received as a different form of value, that is, ACH funds deposited in a non-network FI. R5 represent the ACH funds from S1 being received as a different form of value, that is, ACH funds sent through a third-party P2P network or a social network.

Similarly, the sender may request that value be sourced as funds from a credit or debit card, as shown at S2. The funds sourced at S1 may be received as shown at any of R1, R2, R3, R4, or R5. The sender may request that value be sourced as funds from a pre-paid card, as shown at S3. The funds sourced at 3 may be received as shown at any of R1, R2, R3, R4, or R5. The sender may request that value be sourced as funds from a non-network FI, as shown at S4. The funds sourced at 3 may be received as shown at any of R1, R2, R3, R4, or R5.

The value form and possible combinations shown in FIG. 3 are examples, but are not intended to be exhaustive or limiting. Any value type capable of being electronically transferred may be included in FIG. 3.

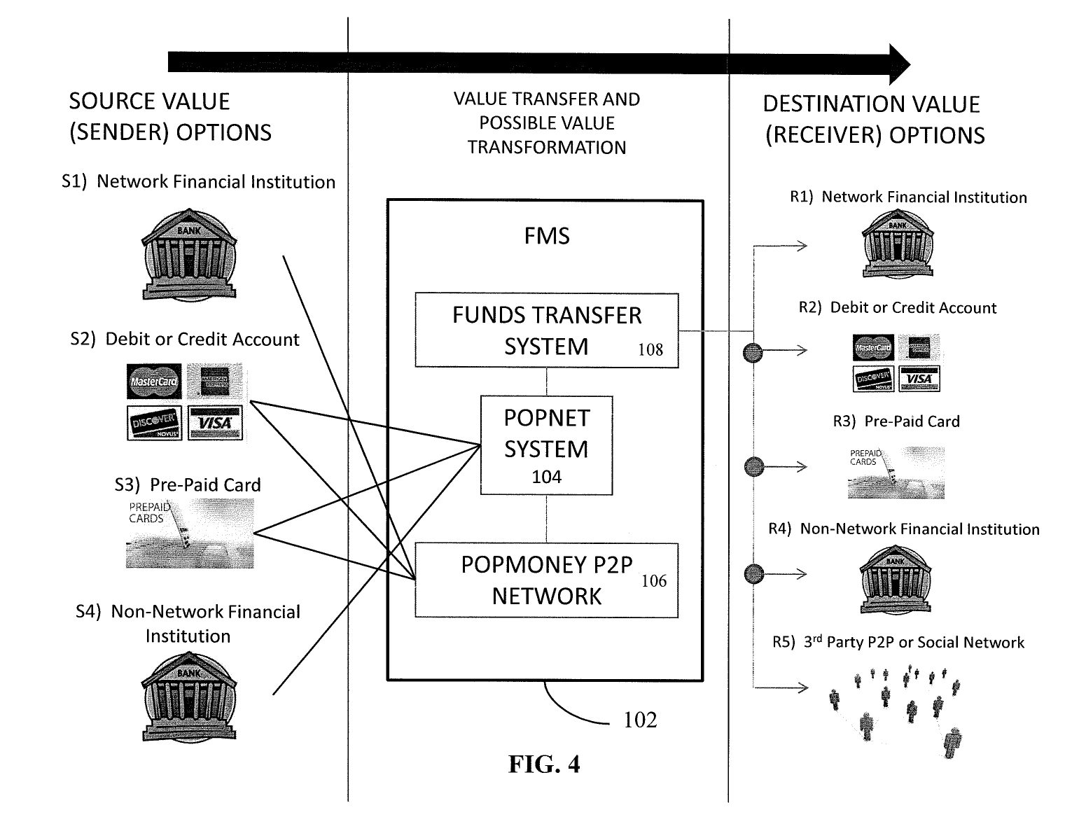

FIG. 4 is a diagram of various value transfer and possible transformation scenarios as carried out at the initiation of the sender by the FMS 102, funds transfer system 108, POPMoney P2P system 104 and POPMoney P2P network 106, starting at the left of the diagram, when the sender initiates a value transfer from a network FI, as shown at S1, the network FI communicates with the POPnet system 104. As shown at S2, when the sender initiates a value transfer from a credit card account or debit card account, the credit card company communicates with the POPnet system 104 if the credit card company is a network member, or with the POPMoney P2P network 106 if the credit card company is not a member. As shown at S3, when the sender initiates a value transfer from a pre-paid card account, the pre-paid card company communicates with the POPnet system 104 if the pre-paid card company is a network member, or with the POPMoney P2P network 106 if the pre-paid card company is not a network member. As shown at S4, when the sender initiates a value transfer from a network FI account, the non-network FI communicates with the POPMoney P2P network 106.

The actual transfer of funds is executed by the funds transfer system 108, and as described and shown with reference to FIG. 3, transfers the value to any one of R1, R2, R3, R4, or R5. The actual transfer of funds takes place after the recipient has been notified, and has chosen a destination value form. This process is not shown in FIG. 4. Note that if the receiver is also a member of the POPMoney network, the receiver may pre-select a destination value.

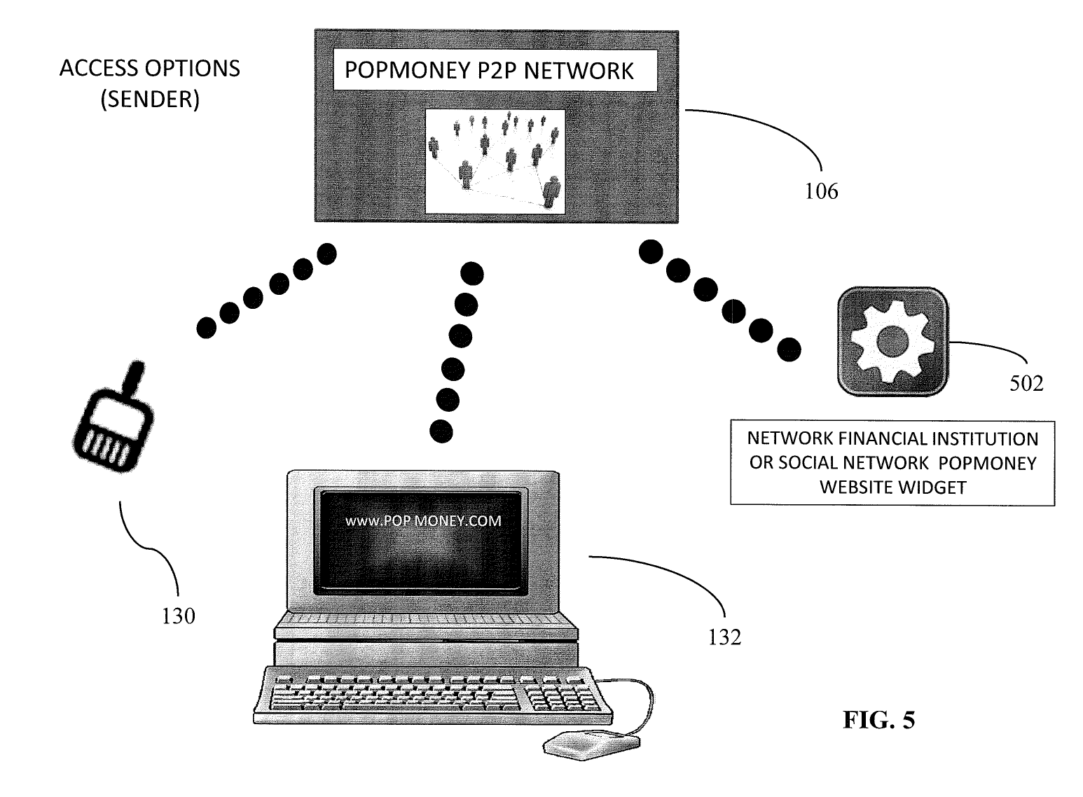

FIG. 5 is a diagram further illustrating sender options for accessing the POPMoney P2P network 106. The residence of PopMoney software widgets on network FI sites, or network social networking sites is shown here. The user may access the POPMoney P2P network 106 using any PDA 130 or PC 132. The user of a PDA 130 may have a mobile application installed which allows the user interact directly with the POPMoney P2P network 106. When the sender is logged onto the www.popmoney.com web site 116, the user is accessing the POPMoney P2P network 106. When the sender is logged onto a network FI site, or network social networking site, the widget communicates with the network POPMoney P2P network 106 on behalf of the sender.

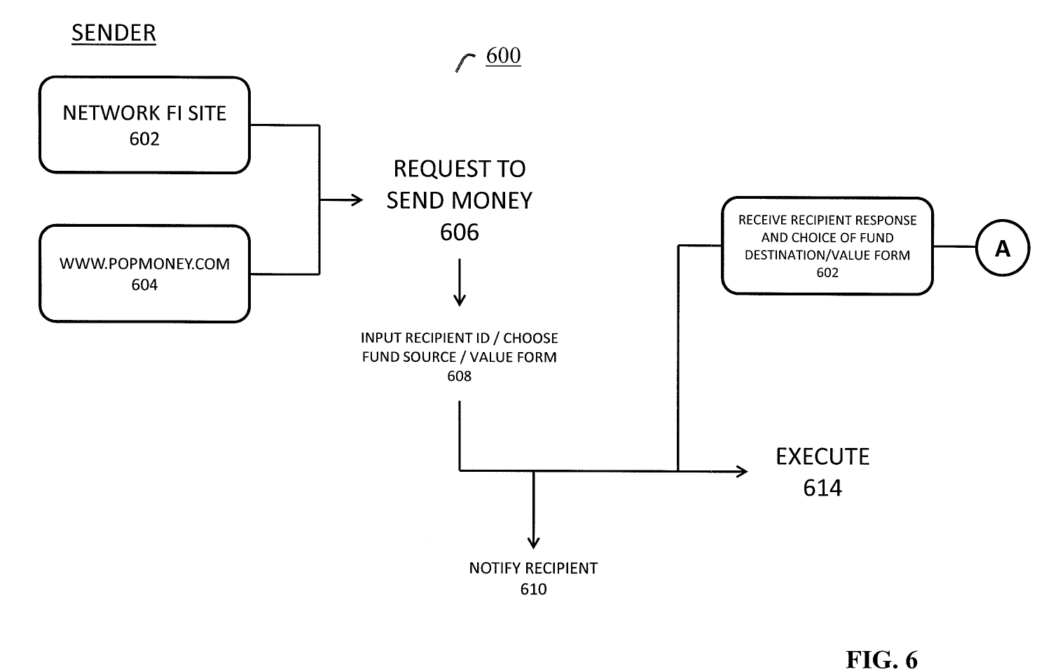

FIG. 6 is a flow chart of a sender-side process 600 of transferring value according to an embodiment. The sender may initiate the value transfer process from a network FI site as shown at 602. The user may also initiate the value transfer process from www.popmoney.com web site 116, as shown at 604. In either the 602 case, or the 604 case, the sender makes a request to send money that is received by the POPnet system 104. The sender inputs a recipient ID, and a fund source/value form as shown at 608 in response to one or more queries. At 610, the recipient is notified of the pending transfer, for example by email or text message, as specified by the recipient ID input by the sender at 608. Once the recipient's response has been received indicating a fund destination/value form, as shown at 612, the transfer is then executed by the FMS 102 at 614. Note that if the recipient is a POPMoney network member, the recipient may pre-select a fund destination/value form.

The sender also has the option of making a decision about the settlement timing of the payment. The sender may choose to send the payment with different settlement time options. For example, the sender may choose to have the funds delivered instantly, in one day, or in three days. The sender may also choose to specify the transaction to be initiated at a future date, in which case the transaction is scheduled, but no funds are moved from the sender account until the specified date and time.

Based on the inputs provided by the sender, the system makes network routing decisions in two steps. The first step is the routing network chosen for withdrawing the funds from the source account. For example, if the sender chooses to fund the transaction from a credit card, the system routes the transaction through the credit card network. The routing decisions may also be impacted by the delivery/settlement time chosen by the sender. For example, the system may connect to the electronic funds transfer (EFT) network if the sender wants funds to be withdrawn from a bank account instantly. The EFT network is just one example of a debit network that may be used. A debit network may offer real-time transactional support (as opposed to transaction batching for execution at fixed intervals). A debit network may include a debit card number as opposed to direct use of a bank account routing number and account number.

As a second step, the system chooses the delivery network based on the choice made by the recipient. For example, if the sender chooses to fund the transaction from a bank account, the system routes the debit transaction through ACH, or alternatively debit or EFT. If the recipient wants to collect the funds at an agent location as cash, then the system routes the transaction to the proprietary network of the designated agent company with the appropriate authentication information for delivery. In this case, the agent location could be domestic or overseas. Geographical location may be a factor in other examples as well. For example, the sender may send funds from a United States bank account, and the recipient may choose to receive the funds on his credit card anywhere outside the United States. These are examples only. There are many embodiments not specifically described in which sender choices and recipient choices are effected within the disconnected system and method.

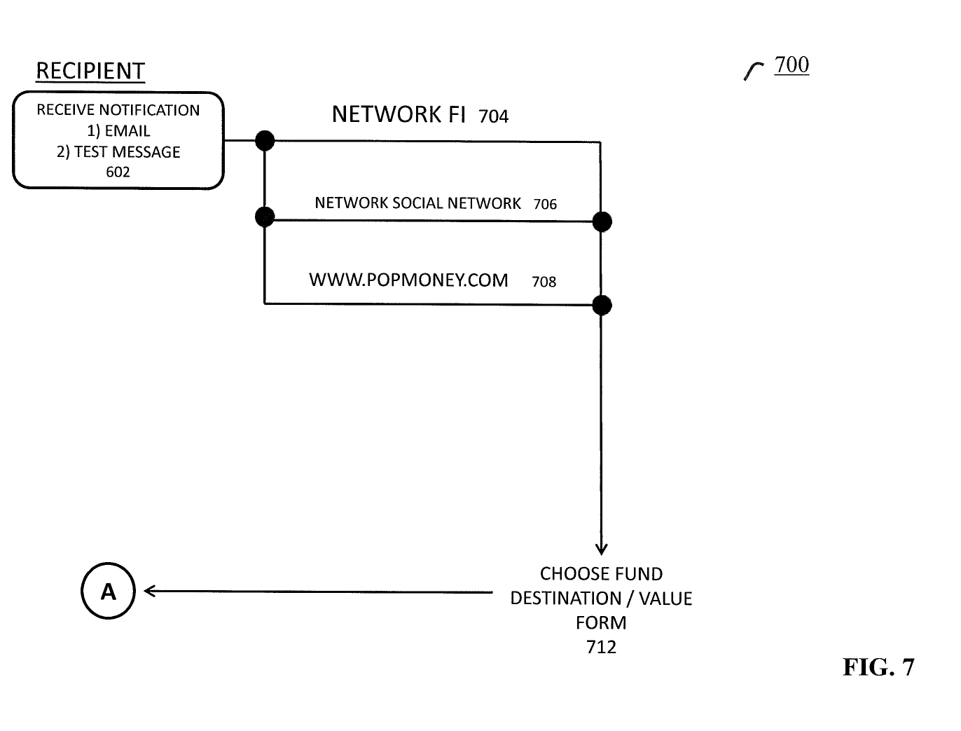

FIG. 7 is a flow chart of a recipient-side process 700 of receiving transferred value according to an embodiment. At 702, the recipient receives notification of the pending transfer by the method chosen by the sender. The recipient may respond by logging onto a web site of their own network FI as shown at 704, by logging onto the recipient's social network which is a network member as shown at 706, or by logging onto the www.popmoney.com web site 116, as shown at 708. In either the 704 case, the 706 case, or the 708 case, the recipient receives (not shown) a query regarding choice of fund destination/value form. At 712, the recipient chooses a fund destination/value form. The choice is received by the POPnet system 104 as shown in FIG. 6, element 612. Note that the receiver in this scenario may not wish to share account information with POPNet. Alternatively, the receiver may indicate a network and a masked account ID so that POPNet may flow the funds through the other network without directly learning any account information.

Upon receiving the notification, the recipient is asked to enter their preference of form in which they would like to receive the value. The recipient may be authenticated to ensure that indeed the email or mobile identification belongs to the intended person. The recipient is offered a number of options. These options could include the following, without limitation:

receive cash at a physical outlet (e.g. Moneygram or Western Union type location);

receive the funds on their credit card as a “reverse” transaction. This could be on a domestic card or overseas card;

receive funds by loading up a re-loadable pre-paid card;

credit funds into their bank account by using a debit card number; and

deposit funds into a bank account by providing a checking or savings or money market account number and routing number.

Each of these choices requires its own information. For example, for a bank account, the user may be prompted to provide an account number and ACH routing number. For the cash pickup, the user may be prompted to provide a cash location and a code that may be required by the agent cash location. In addition, the type of authentication and the fee will differ by the type of destination account chosen.

Once the recipient choices have been made, the funds are transferred by the funds transfer system 108. The transaction may be broken into two steps. The first step involves withdrawing funds from the source account specified by the sender and using an intermediate clearing account to hold the funds. The second step involves transferring the funds from an intermediate clearing account (typically the same one that received the withdrawn funds) to the destination account chosen by the recipient. It should be noted that these functions need not be performed sequentially as described if the FMS 102 is willing to assume risk for the credit based on some sort of risk management.

Aspects of the embodiments described above may be implemented as functionality programmed into any of a variety of circuitry, including but not limited to programmable logic devices (PLDs), such as field programmable gate arrays (FPGAs), programmable array logic (PAL) devices, electrically programmable logic and memory devices, and standard cell-based devices, as well as application specific integrated circuits (ASICs) and fully custom integrated circuits. Some other possibilities for implementing aspects of the embodiments include microcontrollers with memory (such as electronically erasable programmable read only memory (EEPROM), Flash memory, etc.), embedded microprocessors, firmware, software, etc. Furthermore, aspects of the embodiments may be embodied in microprocessors having software-based circuit emulation, discrete logic (sequential and combinatorial), custom devices, fuzzy (neural) logic, quantum devices, and hybrids of any of the above device types. Of course the underlying device technologies may be provided in a variety of component types, e.g., metal-oxide semiconductor field-effect transistor (MOSFET) technologies such as complementary metal-oxide semiconductor (CMOS), bipolar technologies such as emitter-coupled logic (ECL), polymer technologies (e.g., silicon-conjugated polymer and metal-conjugated polymer-metal structures), mixed analog and digital, etc. General purpose computers may be programmed to perform the processes described herein so that the computers become special purpose computers

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number, respectively. Additionally, the words “herein,” “hereunder,” “above,” “below,” and words of similar import, when used in this application, refer to this application as a whole and not to any particular portions of this application. When the word “or” is used in reference to a list of two or more items, that word covers all of the following interpretations of the word, any of the items in the list, all of the items in the list, and any combination of the items in the list.

The above description of illustrated embodiments of the method and system is not intended to be exhaustive or to limit the invention to the precise forms disclosed. While specific embodiments of, and examples for, the method and system are described herein for illustrative purposes, various equivalent modifications are possible within the scope of the invention, as those skilled in the relevant art will recognize.

The various operations described may be performed in a very wide variety of architectures and distributed differently than described. In addition, though many configurations are described herein, none are intended to be limiting or exclusive.

In general, in the following claims, the terms used should not be construed to limit the method and system to the specific embodiments disclosed in the specification and the claims, but should be construed to include any processing systems and methods that operate under the claims. Accordingly, the method and system is not limited by the disclosure, but instead the scope of the method and system is to be determined entirely by the claims.

While certain aspects of the method and system are presented below in certain claim forms, the inventors contemplate the various aspects of the method and system in any number of claim forms. For example, while only one aspect of the method and system may be recited as embodied in computer-readable medium, other aspects may likewise be embodied in computer-readable medium. Computer-readable media include any data storage object readable by a computer including various types of compact disc: (CD-ROM), write-once audio and data storage (CD-R), rewritable media (CD-RW), DVD (Digital Versatile Disc” or “Digital Video Disc), as well as any type of known computer memory device. Such computer readable media may store instructions that are to be executed by a computing device (e.g., personal computer, personal digital assistant, PVR, mobile device or the like) or may be instructions (such as, for example, various hardware description languages) that when executed are designed to create a device (GPU, ASIC, or the like) or software application that when operated performs aspects described above. Accordingly, the inventors reserve the right to add additional claims after filing the application to pursue such additional claim forms for other aspects of the method and system.

What is claimed is:

1. A computer-implemented method performed by a system comprising one or more processors, the method comprising:
a person-to-person (P2P) payment network receiving payment transaction requests from a plurality of P2P payment network members, wherein a payment transaction request comprises,
an identity of a source account belonging to the P2P payment network member, from which funds are to be withdrawn;
a source value form; and
a receiver identity comprising one or more of an email address, and a phone number, wherein the receiver comprises a P2P payment network member, and a P2P payment network non-member;
a P2P payment system facilitating the request, comprising notifying the receiver that the P2P payment network member wishes to send funds to the receiver;
the P2P payment network receiving a response from the recipient, wherein the response comprises,
an identity of a destination account into which the receiver wishes to receive the funds; and
an indication of a destination value form, wherein the destination value form comprises a value form that is the same as the source value form, and a destination value form that is not the same as the source value form;
wherein a value form comprises,
credit card funds;
debit card funds;
pre-paid card funds;
cash to be received at a physical location;
third-party payment networks and
automated clearing house (ACH) funds, including funds from an account in a financial institution;
the P2P payment network facilitating the execution of the requested payment transaction, wherein the transaction comprises withdrawing funds from the source account in the source value form, and depositing destination funds at the destination account in the destination value form.

2. The computer-implemented method of claim 1, wherein the transaction further comprises:
the source funds being held in an intermediate account in the source value form;
funds being transformed from the source value form to the destination value from; and
destination funds being deposited into the destination account.

3. The computer-implemented method of claim 1, further comprising the P2P payment network receiving a transaction request from a P2P payment network member as a communication from a mobile device to the P2P payment network via a P2P payment network web site accessed by the P2P payment network member.

4. The computer-implemented method of claim 1, further comprising the P2P payment network receiving a transaction request from a P2P payment network member as a communication from a mobile device to the P2P payment network via a web site of a member financial institution that is a member of the P2P network, and that hosts a P2P payment system widget.

5. The computer-implemented method of claim 1, wherein a payment transaction request further comprises an identity of a destination account and a destination form value.

6. The computer-implemented method of claim 5, wherein the response from the recipient overrides the identity of a destination account and a destination form value received by from the P2P payment network member.

7. The computer-implemented method of claim 1, wherein the receiver receives the notification in an email.

8. The computer-implemented method of claim 1, wherein the receiver receives the notification in a text message.

9. The computer-implemented method of claim 1, wherein the receiver is a P2P payment network member, and wherein the receiver receives the notification in a message on a proprietary web site of the P2P payment network, and responds via the web site.

10. The computer-implemented method of claim 1, wherein the receiver owns at least one account at a financial institution that is a P2P payment network member, wherein the receiver receives the notification in a message on a proprietary web site of the financial institution using a software widget supplied by the P2P payment network, and responds via the web site.

11. The computer-implemented method of claim 1, wherein the receiver is not a P2P payment network member, and does not own at least one account at a financial institution that is a P2P payment network member, wherein the response includes an identity of a destination account that is at a financial institution that is a P2P payment network member.

12. The computer-implemented method of claim 11, wherein the response includes destination account information, including credential information to allow the P2P payment network to facilitate the execution of the requested payment transaction, wherein the transaction comprises withdrawing funds from the source account in the source value form, and depositing destination funds at the destination account in the destination value form

13. The computer-implemented method of claim 12, wherein the response includes the destination account information in a masked form, and wherein the method further comprises the P2P payment network passing the masked destination account information to the destination such that only the destination institution can store unmask the destination account information.

14. A payment system comprising:
a financial management system coupled to a plurality of financial institutions via the Internet, the financial management system comprising,
a funds transfer system configurable to withdraw funds from a source account, and to deposit the funds in a destination account;
a person-to-person (P2P) payment system coupled to the funds transfer system and configurable to initiate payment transactions on behalf of multiple P2P payment system users, the P2P payment system users comprising P2P payment network members and P2P payment network non-members; and
a person-to-person (P2P) network coupled to the P2P payment system, the P2P payment network comprising multiple internetworking protocols, and multiple user interfaces, wherein the P2P payment network is configurable to,
receive requests from multiple P2P payment network members to initiate payment transactions, a request comprising an identity of a receiver of funds, a source of the funds, and a source value form; and
receive information from the receiver comprising an indication of a payment destination for the funds, and an indication of a destination value form, wherein the destination value form is one of, the same as the source value form, and different from the source value form;
the funds transfer system configurable to withdraw source funds from the source account in the source value form, and deposit funds in the destination account in the destination value form; and
wherein a value form comprises,
credit card funds;
debit card funds; pre-paid card funds;
cash to be received at a physical location;
third-party payment networks; and
automated clearing house (ACH) funds, including funds from an account in a financial institution.

15. The system of claim 14, wherein the P2P payment system is configurable to host a P2P payment network web site through which the P2P payment system is accessible.

16. The system of claim 14, further comprising a plurality of software widgets for facilitating access to the P2P network from a plurality of web sites, comprising web sites of network financial institutions, and network social networking web sites.

17. The system of claim 16, further comprising a proprietary network connection via which the P2P network communicates with the widgets.

18. The system of claim 14, wherein the identity of a receiver of funds comprises an email address, and a phone number.

19. The system of claim 14, wherein the identity of a receiver of funds comprises destination account information, the information comprising,
an account number and routing number;
a credit card number;
a debit card number;
a pre-paid card number, and
a physical location.

20. A non-transitory computer-readable medium, having stored thereon instructions, which when executed by one or more computers cause a person-to-person (P2P) payment method to be performed, the method comprising:
receiving payment transaction requests from a plurality of P2P payment network members, wherein a payment transaction request comprises,
an identity of a source account belonging to the P2P payment network member, from which funds are to be withdrawn;
a source value form; and
a receiver identity comprising one or more of an email address, and a phone number, wherein the receiver comprises a P2P payment network member, and a P2P payment network non-member;
notifying the receiver that the P2P payment network member wishes to send funds to the receiver;
receiving a response from the recipient, wherein the response comprises,
an identity of a destination account into which the receiver wishes to receive the funds; and
an indication of a destination value form, wherein the destination value form comprises a value form that is the same as the source value form, and a destination value form that is not the same as the source value form;
wherein a value form comprises,
credit card funds;
debit card funds;
pre-paid card funds;
cash to be received at a physical location;
third-party payment networks and
automated clearing house (ACH) funds, including funds from an account in a financial institution;
executing the requested payment transaction, wherein the transaction comprises withdrawing funds from the source account in the source value form, and depositing destination funds at the destination account in the destination value form.

21. The computer-readable medium of claim 20, wherein the transaction further comprises:
the source funds being held in an intermediate account in the source value form;
funds being transformed from the source value form to the destination value from; and
destination funds being deposited into the destination account.

22. The computer-readable medium of claim 20, wherein the method further comprises receiving a transaction request from a P2P payment network member as a communication from a mobile device a P2P payment network web site accessed by the P2P payment network member.

23. The computer-readable medium of claim 20, wherein the method further comprises receiving a transaction request from a P2P payment network member as a communication from a mobile device via a web site of a member financial institution that is a member of the P2P network, and that hosts a P2P payment system widget.

24. The computer-readable medium of claim 20 wherein a payment transaction request further comprises an identity of a destination account and a destination form value.

25. The computer-readable medium of claim 24, wherein the response from the recipient overrides the identity of a destination account and a destination form value received by from the P2P payment network member.

26. The computer-readable medium of claim 20, wherein the receiver receives the notification in an email.

27. The computer-readable medium of claim 20, wherein the receiver receives the notification in a text message.

28. The computer-readable medium of claim 20, wherein the receiver is a P2P payment network member, and wherein the receiver receives the notification in a message on a proprietary web site of the P2P payment network, and responds via the web site.

29. The computer-readable medium of claim 20, wherein the receiver owns at least one account at a financial institution that is a P2P payment network member, wherein the receiver receives the notification in a message on a proprietary web site of the financial institution using a software widget supplied by the P2P payment network, and responds via the web site.

30. The computer-readable medium of claim 20, wherein the receiver is not a P2P payment network member, and does not own at least one account at a financial institution that is a P2P payment network member, wherein the response includes an identity of a destination account that is at a financial institution that is a P2P payment network member.

31. The computer-readable medium of claim 30, wherein the response includes destination account information, including credential information to allow the P2P payment network to facilitate the execution of the requested payment transaction, wherein the transaction comprises withdrawing funds from the source account in the source value form, and depositing destination funds at the destination account in the destination value form

32. The computer-readable medium of claim 31, wherein the response includes the destination account information in a masked form, and wherein the method further comprises the P2P payment network passing the masked destination account information to the destination such that only the destination institution can store unmask the destination account information.
